(19) United States
(12) Patent Application Publication
(10) Pub. No.: US 2026/0133723 A1
(43) Pub. Date: May 14, 2026

(54) IMAGE FORMING APPARATUS

(71) Applicant: SHARP KABUSHIKI KAISHA, Osaka (JP)

(72) Inventor: Yuichiro TAKESUE, Osaka (JP)

(21) Appl. No.: 19/382,578

(22) Filed: Nov. 7, 2025

(30) Foreign Application Priority Data
Nov. 12, 2024 (JP) 2024-197506

(51) Int. Cl. G06F 3/12

(52) U.S. Cl. CPC G06F 3/1205; G06F 3/1257

(57) ABSTRACT

The disclosure provides an information processing apparatus that causes the image forming apparatus to appropriately reflect an output result expected from print settings of image data compared to the related art regardless of a difference in applications to be used. A controller determines whether a predetermined print settings save condition has been satisfied if an operation inputter accepts the print execution command of the image data with respect to the image forming apparatus from the application, saves the initial or final print settings of the image data in association with information of the application in a storage if the print settings save condition has been satisfied, and causes the communicator to transmit the image data and the final print settings of the image data to the image forming apparatus, and then causes a display to display a proposal on whether the initial print settings of the image data need to be changed to the final print settings saved in the storage to perform printing if the print settings of the image data have one or more common predetermined setting items to setting items of the initial print settings saved in association with the information of the application in the storage when the operation inputter accepts a print command of the image data from the application, and causes the communicator to transmit the image data and the final print settings saved in the storage to the image forming apparatus when the operation inputter accepts a change command of the print settings.

### CROSS-REFERENCE TO RELATED APPLICATION

The present application claims priority from Japanese Application JP2024-197506, the content to which is hereby incorporated by reference in to this publication.

### Background Art

### Technical Field

The disclosure relates to an information processing apparatus, and, more particularly, to an information processing apparatus that transmits image data and print settings of the image data to an image forming apparatus and causes the image forming apparatus to execute printing.

### Background Art

In the related art, an image forming apparatus such as a Multifunction Peripheral (MFP) prints images based on image data and print settings of the image data received from an information processing apparatus such as a Personal Computer (PC), a smartphone, or a tablet.

As a technique related to printing of such an image forming apparatus, a known technique has been disclosed that, when an information request indicates first contents due to that a specific print application is a first type of a print application, determines first condition information indicating a first print condition as target condition information, and, when the information request indicates second contents different from the first contents due to that the specific print application is a second type of a print application different from the first type of the print application, determines second condition information indicating a second print condition different from the first print condition as the target condition information, and thereby can execute appropriate processing according to the type of the print application of a terminal device.

### SUMMARY

The above-described technique is a technique that executes processing matching a type of a print application for instructing printing to an image forming apparatus. On the other hand, image data created and displayed by an application such as a spreadsheet application, a document creation application, or an image editing application in addition to the print application running on the information processing apparatus is generally transmitted to an image forming apparatus and printed.

When a specific print setting such as double-sided printing or merge printing is made during printing of an image based on image data of such an application, even though the print application and the print settings of the image data are completely the same, an output result may differ depending on an application.

Therefore, a user of the information processing apparatus needs to do trial and error by finely changing print settings of image data for each application to obtain an expected output result from the image forming apparatus, and it cannot be said that user friendliness is high.

The disclosure has been made in view of the above circumstances, and an object thereof is to provide an information processing apparatus that causes an image forming apparatus to appropriately reflect an output result expected from print settings of image data compared to the related art regardless of a difference in applications to be used.

The disclosure provides an information processing apparatus that includes: a storage that stores a program of at least one application that creates or displays image data so as to be able to activate the program; an operator inputter that accepts a command from a user; a display that, when the operation inputter accepts a print command of the image data with respect to an external image forming apparatus, displays a settings screen of print settings of the image data; a communicator that, when the operation inputter accepts a print execution command of the image data with respect to the image forming apparatus, transmits the image data and the print settings; and a controller that controls the storage, the operation inputter, the display, and the communicator, and the controller determines whether a predetermined print settings save condition has been satisfied if the operation inputter accepts the print execution command of the image data from the application, saves the initial or final print settings of the image data in association with information of the application in the storage if the print settings save condition is satisfied, and causes the communicator to transmit the image data and the final print settings of the image data to the image forming apparatus, and then causes the display to display a proposal on whether the initial print settings of the image data need to be changed to the final print settings saved in the storage to perform printing if the print settings of the image data have one or more common predetermined setting items to setting items of the initial print settings saved in association with the information of the application in the storage when the operation inputter accepts the print command of the image data from the application, and causes the communicator to transmit the image data and the final print settings saved in the storage to the image forming apparatus when the operation inputter accepts a change command of the print settings.

According to the disclosure, the “image forming apparatus” is an apparatus that outputs images such as a copier having a copying function such as a printer that uses an electrophotographic method for forming images with toners, or a Multifunction Peripheral (MFP) that also has functions other than copying.

The “initial and final print settings of the image data" are the print settings initially set by the user for the image data and the print settings finally set to OK by the user.

According to the disclosure, if a predetermined print settings save condition has been satisfied, the initial and final print settings are saved in association with the information of the application in the storage, and then, when a print command of image data is accepted, if the print settings have common predetermined setting items to those of the initial print settings saved in association with the information of the application, the display is caused to display a proposal on whether the print settings of the image data need to be changed to the saved final print settings to perform printing, so that it is possible to implement an information processing apparatus that causes the image forming apparatus to appropriately reflect an output result expected from print settings of image data compared to the related art regardless of a difference in applications to be used.

### BRIEF DESCRIPTION OF DRAWINGS

FIG. 1 is an explanatory diagram illustrating an example of an image forming system according to a first embodiment of the disclosure.

FIG. 2 is a block diagram illustrating a schematic configuration of a digital multifunction apparatus illustrated in FIG. 1.

FIG. 3 is a block diagram illustrating a schematic configuration of a user terminal in FIG. 1.

FIG. 4 is an explanatory diagram illustrating an example of a problem of printing processing of a known image forming system.

FIG. 5 is a flow chart illustrating an example of processing of transmitting image data and print settings in the user terminal in FIG. 1 to the digital multifunction apparatus.

FIG. 6 is an explanatory diagram illustrating an example of a print settings screen of a printer driver displayed on a display of the user terminal illustrated in FIG. 1.

FIG. 7 illustrates an example of a proposal of change to final print settings of image data displayed on the display of the user terminal in FIG. 1.

FIG. 8 is a flow chart illustrating an example of printing processing of the digital multifunction apparatus illustrated in FIG. 1.

FIG. 9 is a flow chart illustrating an example of processing of transmitting image data and print settings in the user terminal according to a second embodiment of the disclosure to the digital multifunction apparatus.

FIG. 10 is a flow chart explaining an example of printing processing of the digital multifunction apparatus according to the second embodiment of the disclosure.

FIG. 11 illustrates an example of a proposal of change to the final print settings of image data displayed on the display of the digital multifunction apparatus according to the second embodiment of the disclosure.

FIG. 12 is a flow chart illustrating an example of processing of transmitting image data and print settings in the user terminal according to a third embodiment of the disclosure to the digital multifunction apparatus.

FIG. 13 is an explanatory diagram illustrating an example of a message for inquiring whether the final print settings of the printer driver displayed on the display of the user terminal according to the third embodiment of the disclosure are saved.

FIG. 14 is a flow chart explaining an example of trial printing processing of the digital multifunction apparatus according to a fourth embodiment of the disclosure.

FIG. 15 is a flow chart illustrating an example of processing of transmitting image data and print settings in the user terminal according to a fifth embodiment of the disclosure to the digital multifunction apparatus.

### DESCRIPTION OF THE PREFERRED EMBODIMENTS

Furthermore, preferred aspects of the disclosure will be described.

In the information processing apparatus according to the disclosure, the one or more setting items may include at least one setting item of a merge print setting and a double-sided print setting.

By so doing, when an operation inputter accepts a print command of image data from an application, if the print settings of the image data have at least one common setting item of initial print settings saved in association with information of the application in a storage, the merge print setting, and the double-sided print setting, a display is caused to display a proposal on whether the print settings of the image data need to be changed to the final print settings saved in the storage to perform printing, so that it is possible to implement an information processing apparatus that causes the image forming apparatus to appropriately reflect an output result expected from print settings of image data compared to the related art regardless of a difference in applications to be used.

According to the information processing apparatus according to the disclosure, if the operation inputter accepts the print command of the image data from the same application a predetermined number of times or more within a predetermined time, the controller may determine that the print settings save condition has been satisfied.

By so doing, by determining that the print settings save condition has been satisfied if the print command of the image data of the same application has been repeatedly accepted over and over in a short time, it is possible to implement an information processing apparatus that causes the image forming apparatus to appropriately reflect an output result expected from print settings of image data compared to the related art regardless of a difference in applications to be used.

According to the information processing apparatus according to the disclosure, if the print settings save condition has been satisfied, the controller may save the print setting related to a lastly accepted print command among print commands accepted within a predetermined standby time in association with the information of the application as the final print setting in the storage.

By so doing, if the print command of the image data of the same application has been repeatedly accepted over and over in a short time, the print settings related to the lastly accepted print command are saved as the final print settings, so that it is possible to implement the information processing apparatus that causes the image forming apparatus to appropriately reflect an output result expected from print settings of image data compared to the related art regardless of a difference in applications to be used.

According to the information processing apparatus according to the disclosure, if the operation inputter accepts the print command of the image data from the application, and the operation inputter accepts a command that makes it necessary to save the print settings related to the print command, the controller may save the initial and last print settings in association with the information of the application in the storage, and cause the communicator to transmit the image data and the final print settings of the image data to the image forming apparatus.

By so doing, when the print command of the image data of the application is accepted, if the command that makes it necessary to save the print settings has been accepted from a user, the initial and final print settings are saved in association with the information of the application, so that it is possible to implement the information processing apparatus that causes the image forming apparatus to appropriately reflect an output result expected from print settings of image data compared to the related art regardless of a difference in applications to be used.

Hereinafter, the disclosure will be described in further detail using the drawings. Note that the following description is in all aspects illustrative and it should not be understood as limiting the disclosure.

### First Embodiment

### Configuration of Image Forming System 100

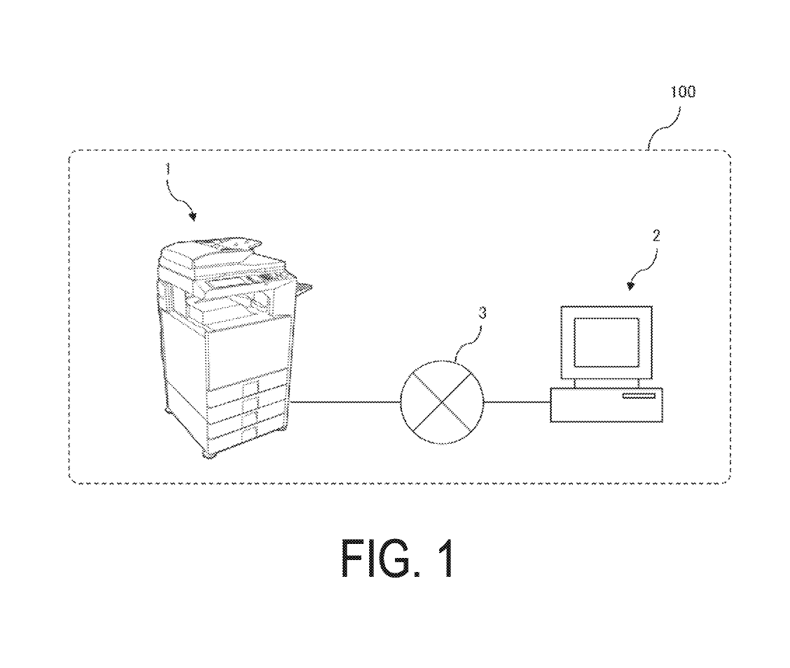

A schematic configuration of an image forming system 100 including a digital multifunction apparatus 1 and a user terminal 2 that are an embodiment of an image forming apparatus and an information processing apparatus according to the disclosure will be described based on FIGS. 1 to 3.

FIG. 1 is an explanatory diagram illustrating an example of a configuration of the image forming system 100 according to a first embodiment of the disclosure.

As illustrated in FIG. 1, the image forming system 100 according to the disclosure includes the digital multifunction apparatus 1 and the user terminal 2 connected through a network 3.

The digital multifunction apparatus 1 is an apparatus such as a multifunction apparatus or an MFP that digitally processes image data and has a copying function, a printer function, a scanner function, and a facsimile function.

The user terminal 2 transmits image data to the digital multifunction apparatus 1, and causes the digital multifunction apparatus 1 to print images based on the image data.

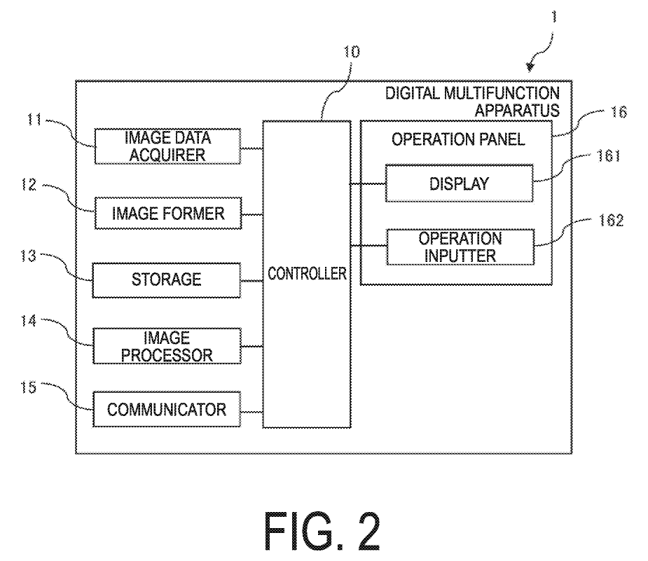

FIG. 2 is a block diagram illustrating the schematic configuration of the digital multifunction apparatus 1 illustrated in FIG. 1.

As illustrated in FIG. 2, the digital multifunction apparatus 1 includes a controller 10, an image data acquirer 11, an image former 12, a storage 13, an image processor 14, a communicator 15, and an operation panel 16.

Hereinafter, each component of the digital multifunction apparatus 1 will be described.

The controller 10 collectively controls the digital multifunction apparatus 1, and includes at least one Central Processing Unit (CPU), at least one System on a Chip (SoC), at least one Random Access Memory (RAM), at least one Read Only Memory (ROM), at least one control circuit, and various interface circuits.

The controller 10 monitors and controls detection of each sensor and all loads such as a motor, a clutch, and the operation panel 16 to control overall operations of the digital multifunction apparatus 1.

The image data acquirer 11 is a part that detects and reads a document placed on a document table or a document conveyed from a document tray, and sets image data. Furthermore, the image data acquirer 11 is a part that acquires image data set by an information processing apparatus such as the user terminal 2, a facsimile device (not illustrated), or the like.

The image former 12 is a part that prints image data acquired by the image data acquirer 11 and processed by the image processor 14 onto a sheet to output.

The storage 13 is an element or a storage medium that stores information necessary to implement various functions of the digital multifunction apparatus 1, control programs, and the like. For example, a semiconductor element such as a RAM or a ROM or a storage medium such as a hard disk, a flash storage, or a Solid State Drive (SSD) is used.

The storage 13 stores image data and data necessary to execute printing of the image data such as print settings of the image data.

The storage 13 temporarily saves the image data and print data including the print settings of the image data accepted from the user terminal 2.

Note that the program and the data may be held in different devices to configure a region for holding data as a hard disk drive and a region for holding the program as a flash storage.

The image processor 14 is a part that converts image data input from the image data acquirer 11 into an appropriate electrical signal, and processes the electrical signal appropriately for output such as enlargement or reduction.

The communicator 15 is a part that communicates with the user terminal 2 via the network 3 and transmits and receives image data and data such as print settings of the image data.

Furthermore, the communicator 15 is a part that communicates with external devices such as the user terminals 2, other image forming apparatuses, mobile information terminals, information processing apparatuses, and facsimile devices, and transmits and receives various types of information such as emails and faxes to and from these external devices.

The operation panel 16 includes a display panel composed of a liquid crystal panel or the like, and a touch panel of a capacitive touch system or the like that is overlaid and placed on the display panel and detects a position touched with a finger, and includes a display 161 and an operation inputter 162.

The display 161 is a part that displays various types of information.

The display 161 includes, for example, a CRT display, a liquid crystal display, an EL display, or the like, and is a display device such as a monitor or a line display used by an operating system and application software to display electronic data such as a processing status.

The display 161 displays an operation and a state of the digital multifunction apparatus 1.

The operation inputter 162 is an interface for operating the digital multifunction apparatus 1 and accepts commands from the user.

### Schematic Configuration of User Terminal 2

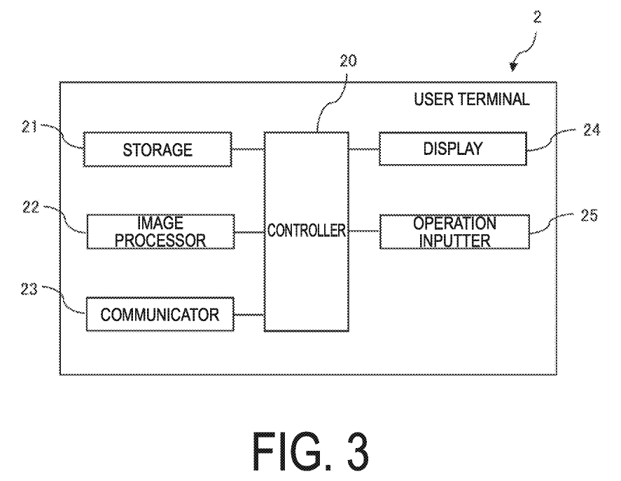

Next, a schematic configuration of the user terminal 2 will be described based on FIG. 3.

FIG. 3 is a block diagram illustrating a schematic configuration of the user terminal 2 in FIG. 1.

As illustrated in FIG. 3, the user terminal 2 includes a controller 20, a storage 21, an image processor 22, a communicator 23, a display 24, and an operation inputter 25.

Hereinafter, each component of the user terminal 2 will be described.

The controller 20 integrally controls the user terminal 2 and includes at least one CPU, at least one SoC, at least one RAM, at least one ROM, at least one control circuit, various interface circuits, and the like.

The controller 20 monitors and controls detection of each sensor and all loads such as the operation inputter 25 to control overall operations of the user terminal 2.

The storage 21 is an element or a storage medium that stores information necessary to implement various functions of the user terminal 2, control programs, and the like. For example, a semiconductor element such as a RAM or a ROM or a storage medium such as a hard disk, a flash storage, or an SSD is used.

The storage 21 saves image data and various data related to printing such as print settings of the image data for causing the digital multifunction apparatus 1 to execute printing.

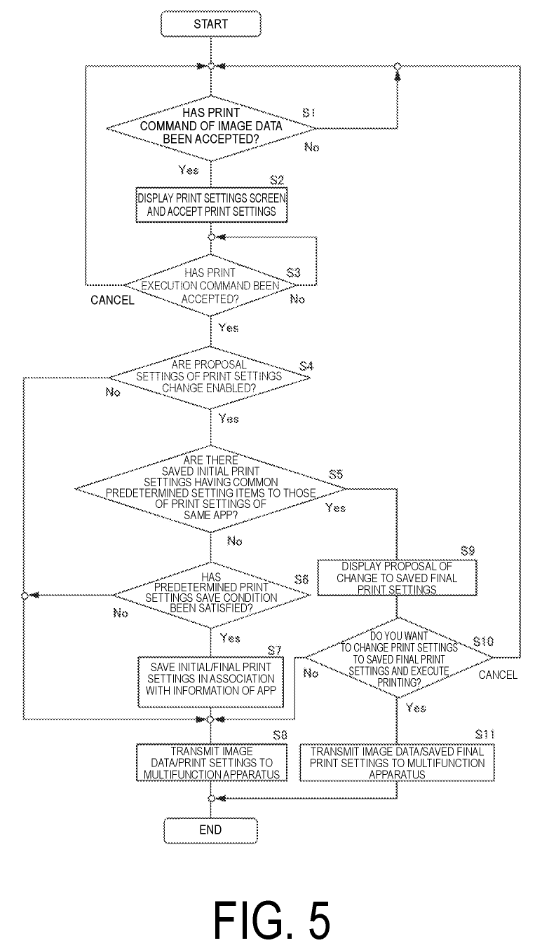

Furthermore, the storage 21 saves the print settings in association with the information of the application as described below with reference to FIG. 5.

Note that the program and the data may be held in different devices to configure the region for holding data as a hard disk drive and the region for holding the program as a flash storage.

The image processor 22 is a part that converts the image data into an appropriate electric signal and processes the electrical signal suitably for output such as enlargement or reduction.

The communicator 23 is a part that communicates with the digital multifunction apparatus 1 via the network 3 and transmits and receives the image data and the data such as the print settings of the image data.

Furthermore, the communicator 23 is a part that communicates with external devices such as the digital multifunction apparatus 1, mobile information terminals, information processing apparatuses, and facsimile devices via the network 3, and transmits and receives various types of information such as emails and faxes to and from these external devices.

The display 24 is a part that displays various types of information.

The display 24 includes, for example, a CRT display, a liquid crystal display, an EL display, or the like, and is a display device such as a monitor or a line display used by an operating system and application software to display electronic data such as a processing status.

The display 24 displays an operation and a state of the user terminal 2.

The operation inputter 25 is an interface for operating the user terminal 2 and is a part that accepts commands from the user.

Note that the display 24 and the operation inputter 25 may include a display panel composed of a liquid crystal panel or the like, and a touch panel of an electrostatic capacitance system that is overlaid and disposed on the display panel and detects a position touched with a finger.

### Problem of Printing Processing of Known Image Forming System 100C

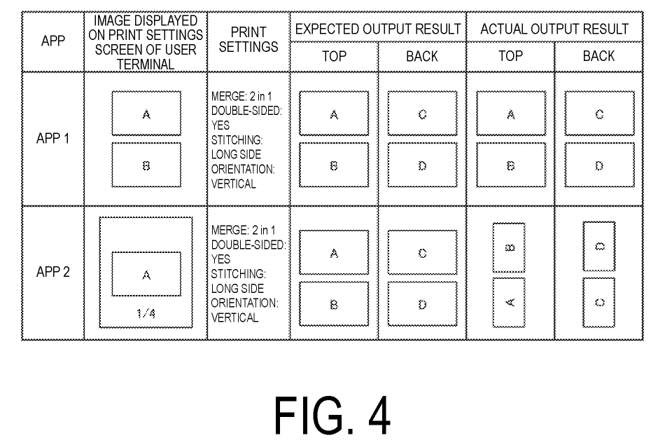

Next, a problem of printing processing of the known image forming system 100C will be described based on FIG. 4.

FIG. 4 is an explanatory diagram illustrating an example of the problem of the printing processing of the known image forming system 100C.

FIG. 4 illustrates examples of preview images displayed on the print settings screen of the display 24 of the user terminal 2, print settings, expected output results, and actual output results for printing of images of two applications (an app 1 and an app 2).

Print settings of the images of the apps 1 and 2 are the same (merge: 2 in 1, double-sided: yes, stitching: long side, and orientation: vertical).

As for printing of an image of the app 1, the expected output result is obtained by vertically merging two images of an image A and an image B on the top surface in the vertical direction, and vertically merging two images of an image C and an image D on the back surface in the vertical direction as illustrated in an example of the app 1 in FIG. 4.

Furthermore, the actual output result matches the expected output result.

On the other hand, as for printing of an image of the app 2, the expected output result is obtained by vertically merging two images of the image A and the image B on the top surface in the vertical direction, and vertically merging two images of the image C and the image D on the back surface in the vertical direction as illustrated in an example of the app 2 in FIG. 4.

However, the actual output result is obtained by merging the two images of the image A and the image B rotated 90 degrees to the left on the top surface in the vertical direction from the bottom, and merging the two images of the image C and the image D rotated 90 degrees to the left on the back surface in the vertical direction from the bottom, and is different from the expected output result.

This is considered to be caused by a difference in specification of each application.

When such a problem occurs, the user needs to do trial and error by finely changing the print settings so as to match the expected result.

However, a relationship between the expected output result and the actual output result varies depending on the application, a result is unknown unless the result is actually output, and therefore it is necessary to do trial and error over and over. Therefore, not only does the user take an effort and time to obtain an expected output result, but also ink and sheets are also wastefully consumed, and therefore it cannot be said that user friendliness is high.

### Printing Processing of Image Forming System 100 According to First Embodiment of Disclosure

Next, printing processing of the image forming system 100 according to the first embodiment of the disclosure will be described based on FIGS. 5 to 8.

FIG. 5 is a flow chart illustrating an example of processing of transmitting image data and print settings in the user terminal 2 in FIG. 1 to the digital multifunction apparatus 1.

In step S1 in FIG. 5, the controller 20 of the user terminal 2 determines whether a print command of image data has been accepted (step S1).

If the print command of the image data has not been accepted (if the determination in step S1 is No), the controller 20 repeats the determination in step S1.

On the other hand, if the print command of the image data has been accepted (if the determination in step S1 is Yes), the controller 20 causes the display 24 to display the print settings screen of the image data and accepts the print settings in step S2 (step S2).

Next, in step S3, the controller 20 determines whether a print execution command of the image data has been accepted (step S3).

If the print execution command of the image data has not been accepted (if the determination in step S3 is No), the controller 20 repeats the determination in step S3.

If execution of printing of the image data has been canceled (if the determination in step S3 is cancel), the controller 20 returns the processing to the determination in step S1.

If the print execution command of the image data has been accepted (if the determination in step S3 is Yes), the controller 20 determines in step S4 whether proposed settings of print settings change of the image data are enabled (step S4).

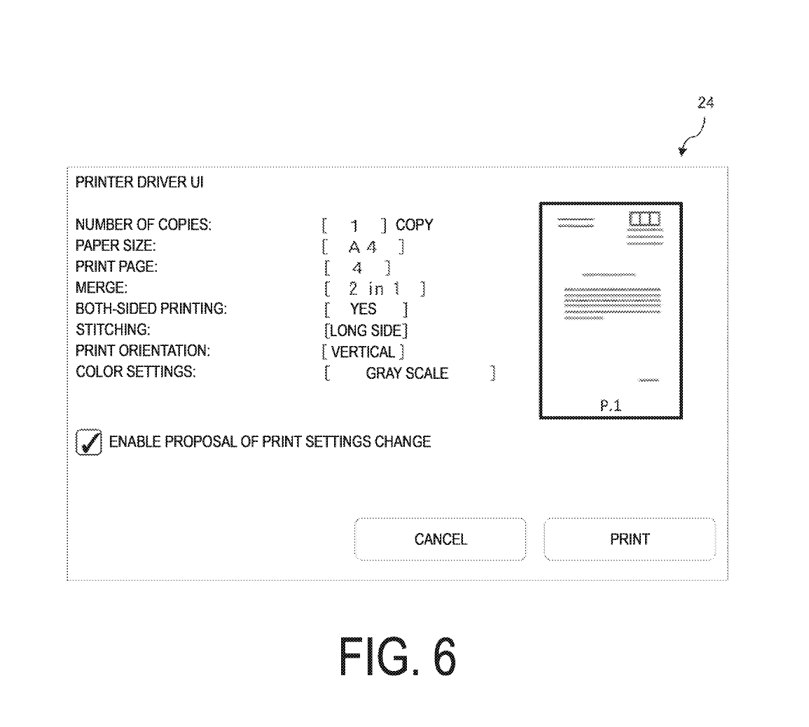

FIG. 6 is an explanatory diagram illustrating an example of the print settings screen of a printer driver displayed on the display 24 of the user terminal 2 illustrated in FIG. 1.

In the example in FIG. 6, the print settings items such as the number of copies "1", a sheet size "A4", the number of print pages "4", merge "2 in 1", double-sided printing "yes", stitching "long side", print orientation "vertical", and the color settings "gray scale" are displayed as a printer driver UI.

Furthermore, a preview image of the image data is displayed next to the print settings items.

Furthermore, a checkbox of "Enable proposal of print settings change" is displayed below the print settings, and the user checks the checkbox if the user wants to enable the proposal of the print settings change of the image data.

If the user instructs the digital multifunction apparatus 1 to execute printing of image data, the user selects a "print" button on the lower right of the screen, and, on the other hand, if the user cancels execution of printing, the user selects a "cancel" button.

In step S4 in FIG. 5, if the proposed settings of the print settings change of the image data are not enabled (if the determination in step S4 is No), the controller 20 causes the communicator 23 to transmit the image data and the print settings of the image data to the digital multifunction apparatus 1 in step S8 (step S8), and ends the processing.

On the other hand, if the proposed settings of the print settings change of the image data are enabled (if the determination in step S4 is Yes), the controller 20 determines in step S5 whether there are initial print settings having one or more common predetermined setting items to those of the print settings of the same application and saved in the storage 21 (step S5).

Here, examples of the one or more predetermined setting items include setting items such as items of merge setting and double-sided printing among the print settings whose print output result usually differs depending on an application.

The controller 20 determines whether these setting items are common, and thereby enables proposal of print settings change if it is considered that the user does trial and error based on the print settings including merge and double-sided printing of the same application.

If there are no initial print settings having the one or more common predetermined setting items to those of the print settings of the same application and saved in the storage 21 (if the determination in step S5 is No), the controller 20 determines in step S6 whether the predetermined print settings save condition has been satisfied (step S6).

Examples of the print settings save condition include a case where a predetermined print instruction for an image of the same application is repeated twice or more in a short time (e.g., one minute).

In this case, examples of a specific print instruction include a print instruction including merge and/or double-sided printing, a print instruction of changing only a print orientation, and the like.

If the above print instruction is repeatedly made in a short time, an output result different from an expected output result is obtained, and therefore it is considered that it is highly probable that the user has changed the print settings and repeatedly made the print instruction.

If the predetermined print settings save condition has not been satisfied (if the determination in step S6 is No), the controller 20 causes the communicator 23 to transmit the image data and the print settings of the image data to the digital multifunction apparatus 1 in step S8 (step S8), and ends the processing.

On the other hand, if the predetermined print settings save condition has been satisfied (if the determination in step S6 is Yes), the controller 20 saves the initial print settings and the final print settings in association with the information of the application in the storage 21 in step S7 (step S7).

That is, the controller 20 saves two print settings of print settings (initial print settings) initially set by the user, and print settings (final print settings) finally set to OK by the user in association with the information of the application in the storage 21.

Thereafter, in step S8, the controller 20 causes the communicator 23 to transmit the image data and the print settings to the digital multifunction apparatus 1 (step S8), and then ends the processing.

Note that, even in any one case of the case where the determination in step S4 is No, the case where the determination in step S6 is No, and the case where the flow comes from the processing in step S7, the print settings that the digital multifunction apparatus 1 is caused to transmit is basically the print settings (final print settings) finally set to OK by the user.

Hereinafter, unless otherwise specified, the print settings that the digital multifunction apparatus 1 is caused to transmit are basically the print settings (final print settings) finally set to OK by the user.

On the other hand, in step S5, if there are the initial print settings having the one or more common predetermined setting items to those of the print settings of the same application and saved in the storage 21 (if the determination in step S5 is Yes), the controller 20 causes the display 24 to display a proposal of change to the final print settings saved in the storage 21 in step S9 (step S9).

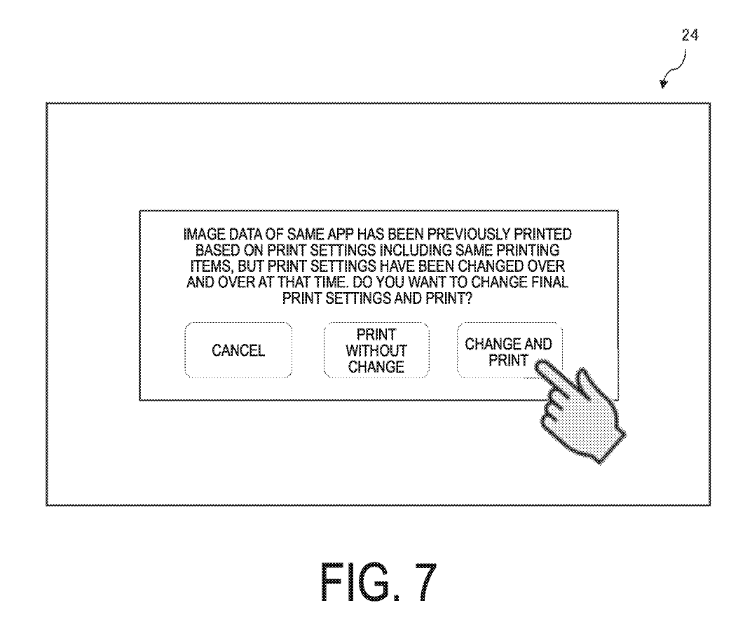

FIG. 7 illustrates an example of a proposal of change to the final print settings of image data displayed on the display 24 of the user terminal 2 illustrated in FIG. 1.

In the example in FIG. 7, a message "image data of same app has been previously printed based on print settings including same printing items, but print settings have been changed over and over at that time. Do you want to change final print settings and print?” is displayed on the display 161.

The user selects one of three buttons, "change and print", "print without change", and "cancel" displayed below the message.

The user selects the "change and print" button if the user changes the print settings of the image data and instructs the digital multifunction apparatus 1 to execute printing, and selects the "print without change" button if the user instructs the digital multifunction apparatus 1 to execute printing without changing the print settings of the image data.

On the other hand, when canceling execution of printing, the user selects the "cancel" button.

Next, in step S10 in FIG. 5, the controller 20 determines whether to change the print settings to the final print settings saved in the storage 21 and execute printing of the image data (step S10).

If the print settings are changed to the final print settings saved in the storage 21 and printing of the image data is executed (if the determination in step S10 is Yes), in step S11, the controller 20 changes the print settings to the final print settings saved in the storage 21 in step S5, then causes the communicator 23 to transmit the image data and the final print settings saved in the storage 21 to the digital multifunction apparatus 1 (step S11), and ends the processing.

On the other hand, if printing of the image data is executed without changing the print settings to the final print settings saved in the storage 21 (if the determination in step S10 is No), the controller 20 causes the communicator 23 to transmit the image data and the print settings to the digital multifunction apparatus 1 in step S8 (step S8), and ends the processing.

Note that the print settings that the digital multifunction apparatus 1 is caused to transmit if the determination in step S10 is No are the print settings finally set to OK by the user (the final print settings that are not saved in the storage 21).

Note that, if execution of printing of the image data has been canceled (if the determination in step S10 is cancel), the controller 20 returns the processing to the determination in step S1.

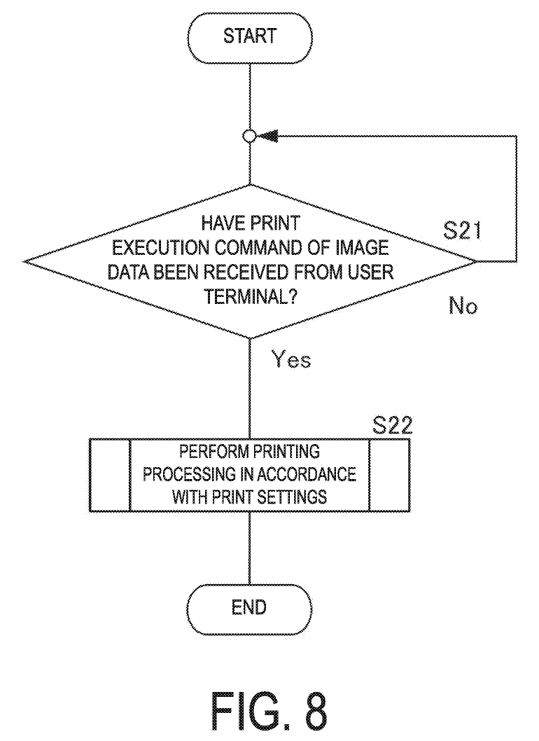

FIG. 8 is a flow chart illustrating an example of the printing processing of the digital multifunction apparatus 1 illustrated in FIG. 1.

In step S21 in FIG. 8, the controller 10 of the digital multifunction apparatus 1 determines whether the print execution command of the image data has been received from the user terminal 2 (step S21).

If the print execution command of the image data is not received from the user terminal 2 (if the determination in step S21 is No), the controller 10 repeats the determination in step S21.

On the other hand, if the print executing command of the image data has been received from the user terminal 2 (if the determination in step S21 is Yes), the controller 10 causes the image former 12 to execute the printing processing of an image based on the image data in accordance with the print settings of the received print executing command in step S22 (step S22), and ends the processing.

As described above, if the predetermined print settings save condition has been satisfied, the initial and final print settings are saved in association with the information of the application in the storage 21, and then, when the print command of the image data is accepted, if the print settings have common predetermined setting items to those of the initial print settings saved in association with the information of the application, the display 24 is caused to display a proposal on whether the print settings of the image data need to be changed to the saved final print settings to perform printing, so that it is possible to implement the user terminal 2 that causes the digital multifunction apparatus 1 to appropriately reflect an output result expected from print settings of the image data compared to the related art regardless of a difference in applications to be used.

### Second Embodiment

### Printing Processing of Image Forming System 100 According to Second Embodiment of Disclosure

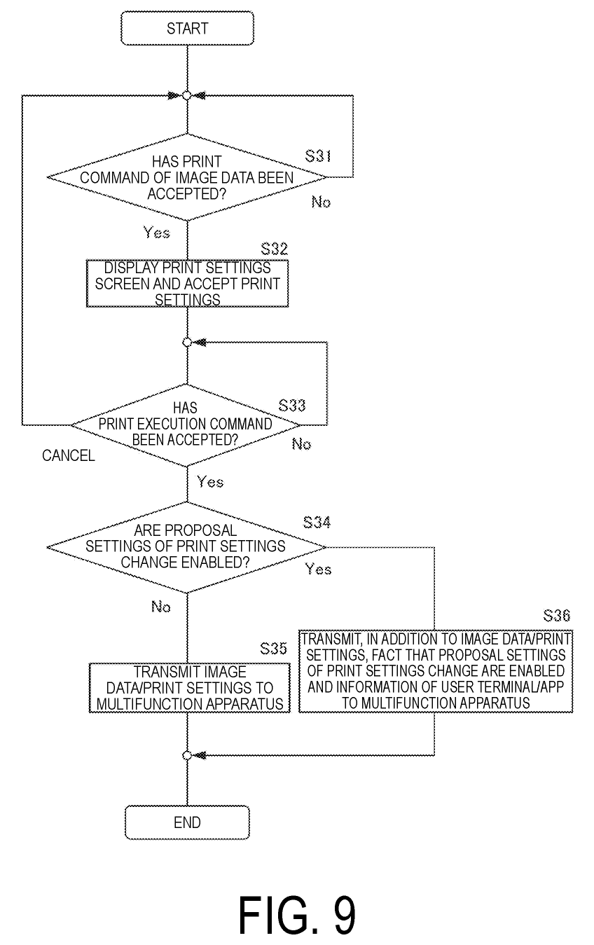

Next, printing processing of the image forming system 100 according to the second embodiment of the disclosure will be described based on FIGS. 9 to 11.

Since the schematic configurations of the image forming system 100, the digital multifunction apparatus 1, and the user terminal 2 according to the second embodiment are the same as those in the first embodiment (FIGS. 1 to 3), description thereof will be omitted.

Features of the image forming system 100 according to the first embodiment include that the user terminal 2 determines whether a predetermined print settings save condition has been satisfied.

On the other hand, features of the image forming system 100 according to the first embodiment include that the digital multifunction apparatus 1 determines whether a predetermined print settings save condition has been satisfied.

FIG. 9 is a flow chart illustrating an example of processing of transmitting image data and print settings in the user terminal 2 according to the second embodiment of the disclosure to the digital multifunction apparatus 1.

In step S31 in FIG. 9, the controller 20 of the user terminal 2 determines whether a print execution command of image data has been accepted (step S31).

If a print command of the image data has not been accepted (if the determination in step S31 is No), the controller 20 repeats the determination in step S31.

On the other hand, if the print command of the image data has been accepted (if the determination in step S31 is Yes), the controller 20 causes the display 24 to display the print settings screen of the image data and accepts the print settings in step S32 (step S32).

Next, in step S33, the controller 20 determines whether the print execution command of the image data has been accepted (step S33).

If the print execution command of the image data has not been accepted (if the determination in step S33 is No), the controller 20 repeats the determination in step S33.

If execution of printing of the image data has been canceled (if the determination in step S33 is cancel), the controller 20 returns the processing to the determination in step S31.

If the print execution command of the image data has been accepted (if the determination in step S33 is Yes), the controller 20 determines in step S34 whether proposed settings of print settings change of the image data are enabled (step S34).

If the proposed settings of the print settings change are not enabled (if the determination in step S34 is No), the controller 20 causes the communicator 23 to transmit the image data and the print settings of the image data to the digital multifunction apparatus 1 in step S35 (step S35), and ends the processing.

On the other hand, if the proposed settings of the print settings change are enabled (if the determination in step S34 is Yes), the controller 20 causes the communicator 23 to transmit a fact that the proposed settings of the print settings change are enabled and information of the user terminal and the application in addition to the image data and the print settings of the image data to the digital multifunction apparatus 1 in step S36 (step S36), and ends the processing.

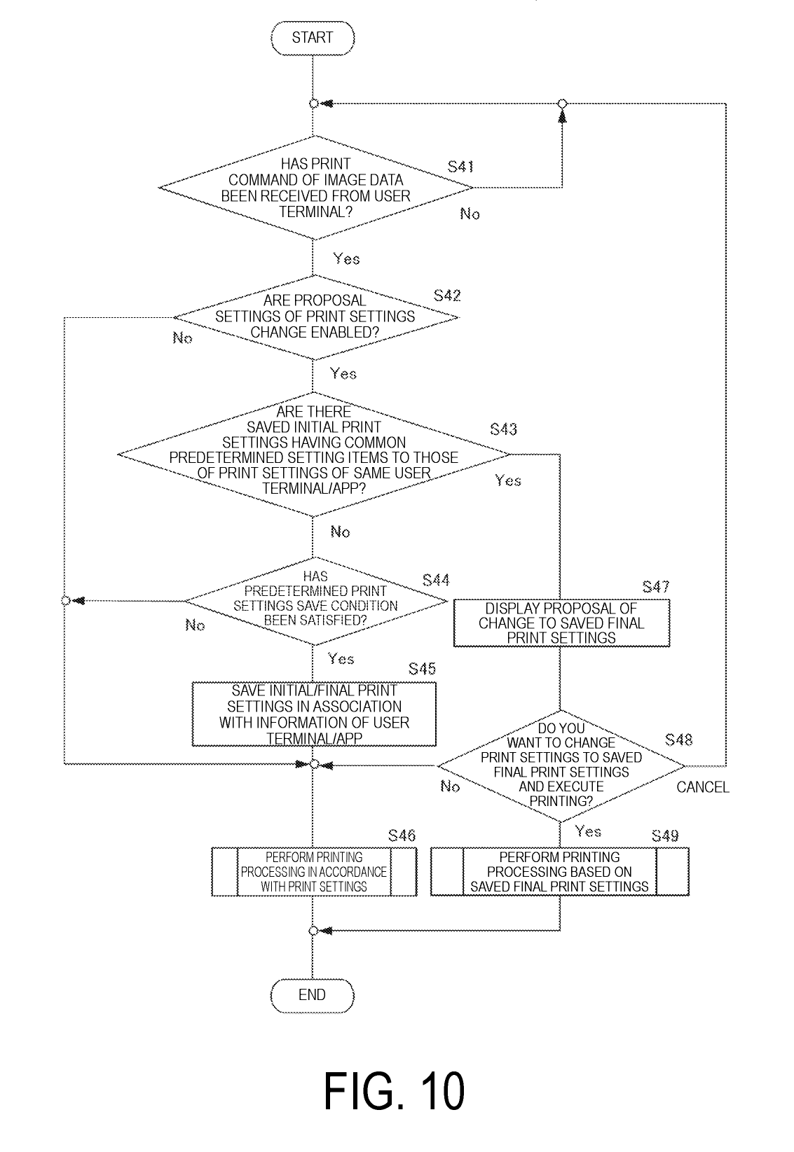

FIG. 10 is a flow chart explaining an example of printing processing of the digital multifunction apparatus 1 according to the second embodiment of the disclosure.

In step S41 in FIG. 10, the controller 10 of the digital multifunction apparatus 1 determines whether the print command of the image data has been received from the user terminal 2 (step S41).

If the print command of the image data is not received from the user terminal 2 (if the determination in step S41 is No), the controller 10 repeats the determination in step S41.

On the other hand, if the print command of the image data has been received from the user terminal 2 (if the determination in step S41 is Yes), the controller 10 determines in step S42 whether the proposed settings of print settings change of the image data are enabled (step S42).

If the proposed settings of the print settings change are not enabled (if the determination in step S42 is No), the controller 10 causes the image former 12 to execute the printing processing in accordance with the print settings in step S46 (step S46).

On the other hand, if the proposed settings of the print settings change are enabled (if the determination in step S42 is Yes), the controller 10 determines in step S43 whether there are initial print settings having one or more common predetermined setting items to those of the print settings of the same user terminal 2/application and saved in the storage 13 (step S43).

If there are no initial print settings having the one or more common predetermined setting items to those of the print settings of the same user terminal 2/application and saved in the storage 13 (if the determination in step S43 is No), the controller 10 determines in step S44 whether the predetermined print settings save condition has been satisfied (step S44).

Examples of the print settings save condition include a case where a specific print instruction for image data of the same application from the same user terminal 2 is repeated twice or more in a short time (e.g., one minute).

In this case, examples of the specific print instruction include a print instruction including merge and/or double-sided printing, a print instruction of changing only a print orientation, and the like.

When the above print instruction is repeatedly made in a short time, an output result different from an expected output result is obtained, and therefore it is considered that it is highly probable that the same user has changed the print settings and repeatedly made the print instruction.

If the predetermined print settings save condition has not been satisfied (if the determination in step S44 is No), the controller 10 causes the image former 12 to execute the printing processing in accordance with the print settings in step S46 (step S46), and ends the processing.

On the other hand, if the predetermined print settings save condition has been satisfied (if the determination in step S44 is Yes), the controller 10 saves the initial print settings and the final print settings in association with the information of the user terminal 2/application in the storage 13 in step S45 (step S45).

Thereafter, the controller 10 causes the image former 12 to execute the printing processing in accordance with the print settings in step S46 (step S46), and ends the processing.

On the other hand, in step S43, if there are the initial print settings having the one or more common predetermined setting items to those of the print settings of the user terminal 2/same application and saved in the storage 13 (if the determination in step S43 is Yes), the controller 10 causes the display 161 to display a proposal of change to the final print settings saved in the storage 13 in step S47 (step S47).

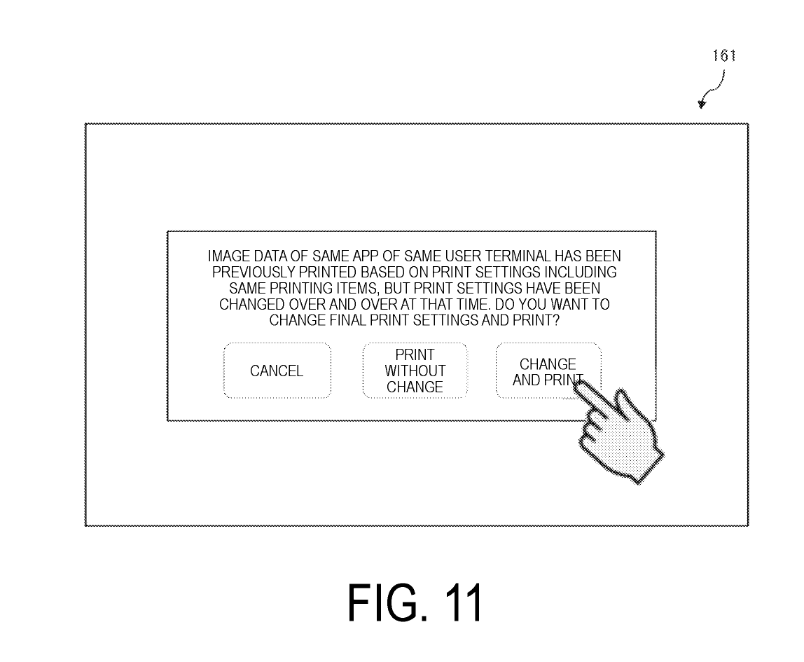

FIG. 11 illustrates an example of a proposal of change to the final print settings of image data displayed on the display 161 of the digital multifunction apparatus 1 according to the second embodiment of the disclosure.

In the example in FIG. 11, a message "image data of same app of same user terminal has been previously printed based on print settings including same printing items, but print settings have been changed over and over at that time. Do you want to change final print settings to print?” is displayed on the display 161.

The user selects one of the three buttons "change and print", "print without change", and "cancel" displayed below the message.

Next, in step S48 in FIG. 10, the controller 10 determines whether to change the print settings to the final print settings saved in the storage 13 and execute printing of the image data (step S48).

If the print settings are changed to the final print settings saved in the storage 13 and printing of the image data is executed (if the determination in step S48 is Yes), in step S49, the controller 10 changes the print settings to the final print settings saved in the storage 13 in step S45, then causes the image former 12 to execute the printing processing (step S49), and ends the processing.

On the other hand, if printing of the image data is executed without changing the print settings to the final print settings saved in the storage 13 (if the determination in step S48 is No), the controller 10 causes the image former 12 to execute the printing processing in accordance with the print settings in step S46 (step S46), and ends the processing.

Note that, if execution of printing has been canceled (if the determination in step S48 is cancel), the controller 10 returns the processing to the determination in step S41.

Since the printing processing of the digital multifunction apparatus 1 according to the second embodiment of the disclosure is the same as that in the first embodiment (FIG. 8), description thereof will be omitted.

As described above, if the predetermined print settings save condition has been satisfied, the initial and final print settings are saved in association with the information of the user terminal 2/application in the storage 13, and then, when the print command of the image data is accepted, if the print settings have common predetermined setting items to those of the initial print settings saved in association with the information of the application, the display 161 is caused to display a proposal on whether the print settings of the image data need to be changed to the saved final print settings to perform printing, so that it is possible to implement the digital multifunction apparatus 1 that appropriately reflects an output result expected from print settings of the image data compared to the related art regardless of a difference in applications to be used by the user terminal 2.

### Third Embodiment

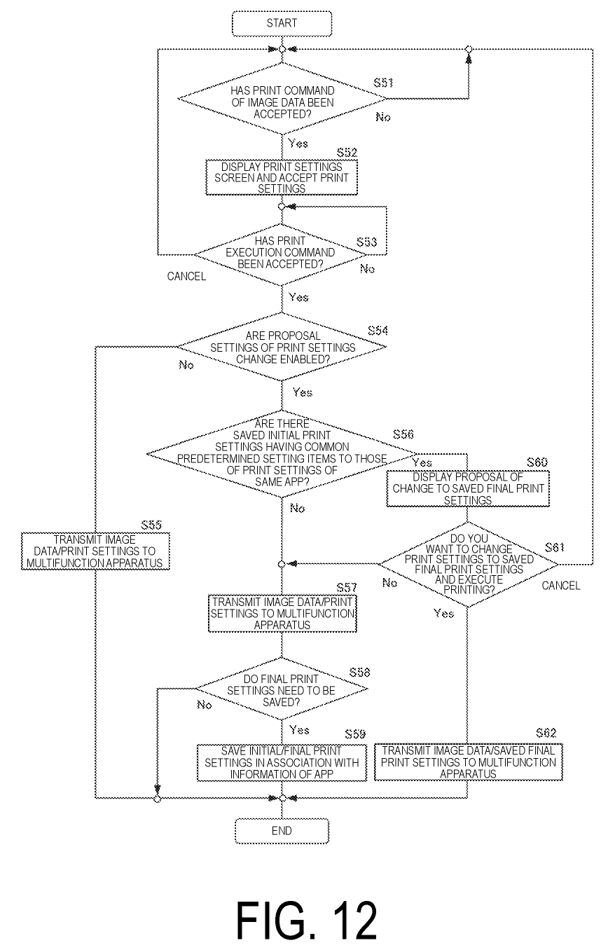

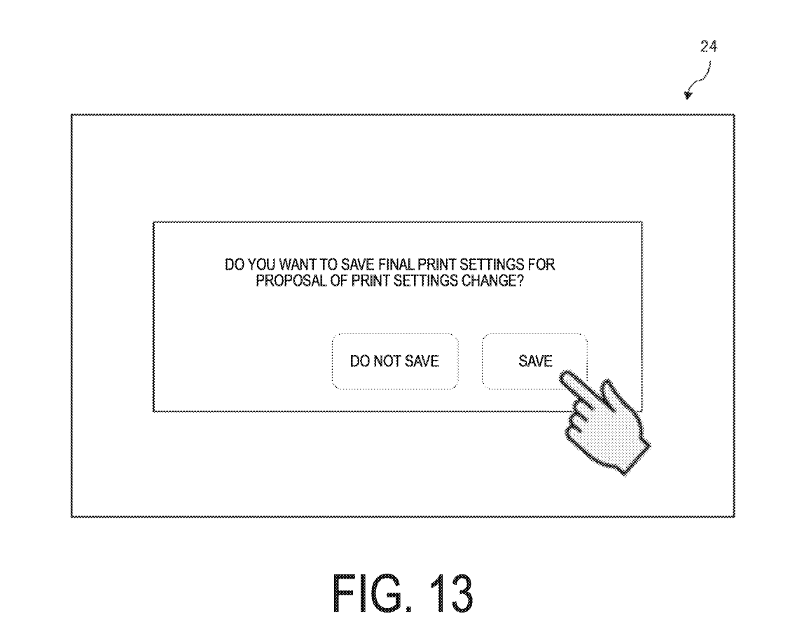

Next, processing of transmitting image data and print settings in the user terminal 2 according to the third embodiment of the disclosure to the digital multifunction apparatus 1 will be described based on FIGS. 12 and 13.

FIG. 12 is a flow chart illustrating an example of processing of transmitting the image data and the print settings in the user terminal 2 according to the third embodiment of the disclosure to the digital multifunction apparatus 1.

Since the schematic configurations of the image forming system 100, the digital multifunction apparatus 1, and the user terminal 2 according to the third embodiment are the same as those in the first embodiment (FIGS. 1 to 3), description thereof will be omitted.

Features of the image forming system 100 according to the first and second embodiments include that the image forming system 100 determines whether a predetermined print settings save condition has been satisfied, and, if the print settings save condition has been satisfied, saves the print settings to use for a proposal of settings change of the print settings.

On the other hand, features of the image forming system 100 according to the third embodiment include that the image forming system 100 saves the print settings for each application, and causes the user to determine whether to use the print settings for the proposal of the setting change of the print settings.

FIG. 12 is a flowchart illustrating an example of processing of transmitting the image data and the print settings in the user terminal 2 according to the third embodiment of the disclosure to the digital multifunction apparatus 1.

In step S51 in FIG. 12, the controller 20 of the user terminal 2 determines whether a print command of image data has been accepted (step S51).

If the print command of the image data has not been accepted (if the determination in step S51 is No), the controller 20 repeats the determination in step S51.

On the other hand, if the print command of the image data has been accepted (if the determination in step S51 is Yes), the controller 20 causes the display 24 to display the print settings screen and accepts the print settings in step S52 (step S52).

Next, in step S53, the controller 20 determines whether a print execution command of the image data has been accepted (step S53).

If the print execution command of the image data has not been accepted (if the determination in step S53 is No), the controller 20 repeats the determination in step S53.

If execution of printing of the image data has been canceled (if the determination in step S53 is cancel), the controller 20 returns the processing to the determination in step S51.

If the print execution command of the image data has been accepted (if the determination in step S53 is Yes), the controller 20 determines in step S54 whether proposed settings of print settings change of the image data are enabled (step S54).

If the proposed settings of the print settings change of the image data are not enabled (if the determination in step S54 is No), the controller 20 causes the communicator 23 to transmit the image data and the print settings of the image data to the digital multifunction apparatus 1 in step S55 (step S55), and ends the processing.

On the other hand, if the proposed settings of the print settings change of the image data are enabled (if the determination in step S54 is Yes), the controller 20 determines in step S56 whether there are initial print settings having one or more common predetermined setting items to those of the print settings of the same application and saved in the storage 21 (step S56).

If there are no initial print settings having the one or more common predetermined setting items to those of the print settings of the same application and saved in the storage 21 (if the determination in step S56 is No), the controller 20 causes the communicator 23 to transmit the image data and the print settings of the image data to the digital multifunction apparatus 1 in step S57 (step S57).

Next, in step S58, the controller 20 causes the display 24 to display a message for inquiring of the user whether the final print settings need to be saved for the proposal of the print settings change of the image data to make a determination (step S58).

FIG. 13 is an explanatory diagram illustrating an example of a message for inquiring whether the final print settings of the printer driver displayed on the display 24 of the user terminal 2 according to the third embodiment of the disclosure are saved.

In the example in FIG. 13, a message "Do you want to save final print settings for proposal of print settings change?” is displayed on the display 24.

The user selects a "save" button below the message when the user wants to save the final print settings, and selects a "do not save" button when the user does not want to save the final print settings.

If the final print settings need to be saved for the proposal of the print settings change of the image data in step S58 in FIG. 12 (if the determination in step S58 is Yes), the controller 20 saves the initial print settings and the final print settings in association with the information of the application in the storage 21 in step S59 (step S59), and ends the processing.

On the other hand, if the final proposed settings do not need to be saved for the proposal of the print settings change of the image data (if the determination in step S58 is No), the controller 20 ends the processing.

In step S56, if there are the initial print settings having the one or more common predetermined setting items to those of the print settings of the same application and saved in the storage 21 (if the determination in step S56 is Yes), the controller 20 causes the display 24 to display the proposal of change to the final print settings saved in the storage 21 in step S60 (step S60).

In subsequent step S61, the controller 20 determines whether to change the print settings to the final print settings saved in the storage 21 and execute printing of the image data (step S61).

If the print settings are changed to the final print settings saved in the storage 21 and printing of the image data is executed (if the determination in step S61 is Yes), in step S62, the controller 20 changes the print settings to the final print settings saved in the storage 21 in step S59, then causes the communicator 23 to transmit the image data and the final print settings saved in the storage 21 to the digital multifunction apparatus 1 (step S62), and ends the processing.

On the other hand, if printing of the image data is executed without changing the print settings to the final print settings saved in the storage 21 (if the determination in step S61 is No), the controller 20 causes the communicator 23 to transmit the image data and the print settings to the digital multifunction apparatus 1 in step S57 (step S57).

Note that, if execution of printing of the image data has been canceled (if the determination in step S61 is cancel), the controller 20 returns the processing to the determination in step S51.

Since the printing processing of the digital multifunction apparatus 1 according to the third embodiment of the disclosure is the same as that in the first embodiment (FIG. 8), description thereof will be omitted.

By so doing, when the print execution command of the image data from the application is accepted, if the command that makes it necessary to save the print settings is accepted from the user, the initial and final print settings are saved in association with the information of the application in the storage 21, so that it is possible to implement the user terminal 2 that causes the digital multifunction apparatus 1 to appropriately reflect an output result expected from print settings of the image data compared to the related art regardless of a difference in applications to be used.

### Fourth Embodiment

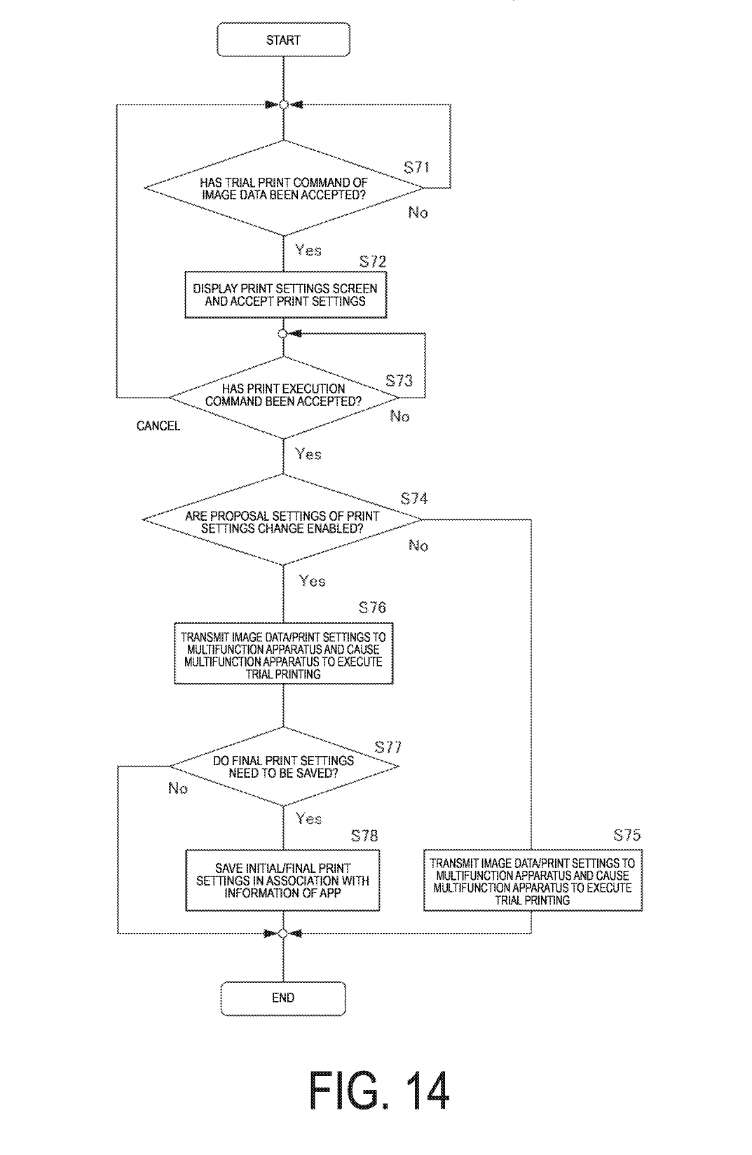

Next, trial printing processing of the digital multifunction apparatus 1 in the user terminal 2 according to a fourth embodiment of the disclosure will be described based on FIG. 14.

FIG. 14 is a flow chart explaining an example of the trial printing processing of the digital multifunction apparatus 1 according to the fourth embodiment of the disclosure.

Since the schematic configurations of the image forming system 100, the digital multifunction apparatus 1, and the user terminal 2 according to the fourth embodiment are the same as those in the first embodiment (FIGS. 1 to 3), description thereof will be omitted.

Features of the image forming system 100 according to the first to third embodiments include that the image forming system 100 determines whether the print settings of the image data need to be saved when causing the digital multifunction apparatus 1 to execute printing of image data, and proposes settings change of the print settings based on the saved print settings when printing next and subsequent image data.

On the other hand, features of the image forming system 100 according to the fourth embodiment include that the image forming system 100 determines whether the print settings of the image data need to be saved when further causing the digital multifunction apparatus 1 to execute trial printing of the image data, and proposes settings change of the print settings based on the saved print settings when printing next and subsequent image data.

FIG. 14 is a flowchart explaining an example of the trial printing processing of the digital multifunction apparatus 1 according to the fourth embodiment of the disclosure.

In step S71 in FIG. 14, the controller 20 of the user terminal 2 determines whether a trial print command of image data has been accepted (step S71).

The trial printing is a function of performing printing while suppressing an amount of toner used for printing than usual.

If the trial print command of the image data has not been accepted (if the determination in step S71 is No), the controller 20 repeats the determination in step S71.

On the other hand, if the trial print command of the image data has been accepted (if the determination in step S71 is Yes), the controller 20 causes the display 24 to display the print settings screen of the image data and accepts the print settings in step S72 (step S72).

Next, in step S73, the controller 20 determines whether a print execution command of the image data has been accepted (step S73).

If the print execution command has not been accepted (if the determination in step S73 is No), the controller 20 repeats the determination in step S73.

If execution of printing has been canceled (if the determination in step S73 is cancel), the controller 20 returns the processing to the determination in step S71.

If the print execution command has been accepted (if the determination in step S73 is Yes), the controller 20 determines in step S74 whether proposed settings of print settings change of the image data are enabled (step S74).

If the proposed settings of the print settings change of the image data are not enabled (if the determination in step S74 is No), the controller 20 causes the communicator 23 to transmit the image data and the print settings of the image data to the digital multifunction apparatus 1 in step S75 (step S75), and ends the processing.

On the other hand, if the proposed settings of the print settings change of the image data are enabled (if the determination in step S74 is Yes), the controller 20 causes the communicator 23 to transmit the image data and the print settings of the image data to the digital multifunction apparatus 1 to execute trial printing in step S76 (step S76).

Next, in step S77, the controller 20 causes the display 24 to display a message for inquiring of the user whether the final print settings need to be saved for the proposal of the print settings change of the image data to make a determination (step S77).

If the final print settings for a proposal of the print settings change of the image data do not need to be saved (if the determination in step S77 is No), the controller 20 ends the processing.

On the other hand, if the final print settings need to be saved for the proposal of the print settings change of the image data (if the determination in step S77 is Yes), the controller 20 saves the initial print settings and the final print settings in association with the information of the application in the storage 21 in step S78 (step S78), and ends the processing.

Note that the processing of transmitting the image data and the print settings in the user terminal 2 according to the fourth embodiment of the disclosure to the digital multifunction apparatus 1 is the same as that in the first embodiment (FIG. 5), description thereof will be omitted.

Furthermore, since the printing processing of the digital multifunction apparatus 1 according to the fourth embodiment of the disclosure is the same as that in the first embodiment (FIG. 8), description thereof will be omitted.

By so doing, when trial printing of image data of the application is performed, whether print settings of the image data need to be saved is inquired, and, if the print settings need to be saved, the initial and final print settings are saved in association with the information of the application in the storage 21, so that it is possible to implement the user terminal 2 that causes the digital multifunction apparatus 1 to appropriately reflect an output result expected from print settings of the image data compared to the related art regardless of a difference in applications to be used while suppressing toner consumption compared to the related art.

### Fifth Embodiment

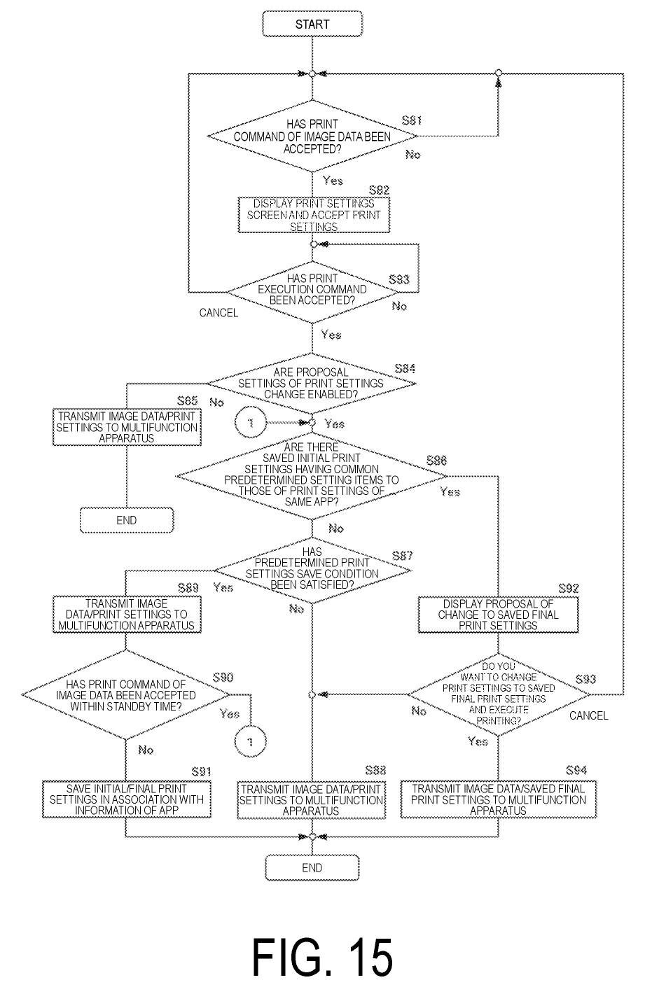

Next, printing processing of the image forming system 100 according to the fifth embodiment of the disclosure will be described based on FIG. 15.

Since the schematic configurations of the image forming system 100, the digital multifunction apparatus 1, and the user terminal 2 according to the fifth embodiment are the same as those in the first embodiment (FIGS. 1 to 3), description thereof will be omitted.

The example where the print settings save condition in step S4 in FIG. 5 includes the case where a predetermined print instruction for an image of the same application is repeated twice or more in a short time (e.g., one minute) has been cited and described in the first embodiment.

On the other hand, it is assumed that, when a predetermined print instruction for an image of the same application is repeated three times in a short time, there is no fourth print instruction. In this case, it is considered that an expected output result cannot be obtained from the first and second print settings, and the expected output result can be finally obtained from the third print settings.

Therefore, features of the image forming system 100 according to the fifth embodiment of the disclosure include that, even if the predetermined print settings save condition has been satisfied, and, if a predetermined print instruction for an image of the same application has been made within a predetermined standby time (e.g., within three minutes), the print settings are not saved assuming that an expected output result has not been obtained, and, if the predetermined print instruction for the image of the same application has not been made within the standby time, the final print settings are saved assuming that the expected output result has been obtained.

FIG. 15 is a flow chart illustrating an example of processing of transmitting image data and print settings in the user terminal 2 according to the fifth embodiment of the disclosure to the digital multifunction apparatus 1.

In step S81 in FIG. 15, the controller 20 of the user terminal 2 determines whether a print command of image data has been accepted (step S81).

If the print command of the image data has not been accepted (if the determination in step S81 is No), the controller 20 repeats the determination in step S81.

On the other hand, if the print command of the image data has been accepted (if the determination in step S81 is Yes), the controller 20 causes the display 24 to display the print settings screen of the image data and accepts the print settings in step S82 (step S82).

Next, in step S83, the controller 20 determines whether a print execution command of the image data has been accepted (step S83).

If the print execution command of the image data has not been accepted (if the determination in step S83 is No), the controller 20 returns the determination in step S83.

If execution of printing of the image data has been canceled (if the determination in step S83 is cancel), the controller 20 returns the processing to the determination in step S81.

If the print execution command of the image data has been accepted (if the determination in step S83 is Yes), the controller 20 determines in step S84 whether the proposed settings of print settings change are enabled (step S84).

If the proposed settings of the print settings change of the image data are not enabled (if the determination in step S84 is No), the controller 20 causes the communicator 23 to transmit the image data and the print settings of the image data to the digital multifunction apparatus 1 in step S85 (step S85), and ends the processing.

On the other hand, if the proposed settings of the print settings change of the image data are enabled (if the determination in step S84 is Yes), the controller 20 determines in step S86 whether there are initial print settings having one or more common predetermined setting items to those of the print settings of the same application and saved in the storage 21 (step S86).

If there are no initial print settings having the one or more common predetermined setting items to those of the print settings of the same application and saved in the storage 21 (if the determination in step S86 is No), the controller 20 determines in step S87 whether the predetermined print settings save condition has been satisfied (step S87).

If the predetermined print settings save condition has not been satisfied (if the determination in step S87 is No), the controller 20 causes the communicator 23 to transmit the image data and the print settings of the image data to the digital multifunction apparatus 1 in step S88 (step S88), and ends the processing.

If the predetermined print settings save condition has been satisfied (if the determination in step S87 is Yes), the controller 20 causes the communicator 23 to transmit the image data and the print settings of the image data to the digital multifunction apparatus 1 in step S89 (step S89).

In subsequent step S90, the controller 20 causes the communicator 23 to transmit the image data and the print settings of the image data to the digital multifunction apparatus 1, and then determines whether the print command of the image data has been accepted within a predetermined standby time (e.g., three minutes) (step S90).

If the print command of the image data has been accepted within the predetermined standby time (e.g., three minutes) (if the determination in step S90 is Yes), the controller 20 returns the processing to the determination in step S86.

On the other hand, if the print command of the image data has not been accepted within the predetermined standby time (e.g., three minutes) (if the determination in step S90 is No), the controller 20 saves the initial print settings and the final print settings in association with the information of the application in the storage 21 in step S91 (step S91), and ends the processing.

On the other hand, in step S86, if there are the initial print settings having the one or more common predetermined setting items to those of the print settings of the same application and saved in the storage 21 (if the determination in step S86 is Yes), the controller 20 causes the display 24 to display a proposal of change to the final print settings saved in the storage 21 in step S92 (step S92).

In subsequent step S93, the controller 20 determines whether to change the print settings to the final print settings saved in the storage 21 and execute printing of the image data (step S93).

If the print settings are changed to the final print settings saved in the storage 21 and printing of the image data is executed (if the determination in step S71 is Yes), in step S94, the controller 20 changes the print settings to the final print settings saved in the storage 21 in step S91, then causes the communicator 23 to transmit the image data and the final print settings saved in the storage 21 to the digital multifunction apparatus 1 (step S94), and ends the processing.

On the other hand, if printing of the image data is executed without changing the print settings to the final print settings saved in the storage 21 (if the determination in step S93 is No), the controller 20 causes the communicator 23 to transmit the image data and the print settings to the digital multifunction apparatus 1 in step S88 (step S88), and ends the processing.

If execution of printing of the image data has been canceled (if the determination in step S93 is cancel), the controller 20 returns the processing to the determination in step S81.

Since the printing processing of the digital multifunction apparatus 1 according to the fifth embodiment of the disclosure is the same as that in the first embodiment (FIG. 8), description thereof will be omitted.

By so doing, if the print command of the image data of the same application has been repeatedly accepted over and over in a short time, the print settings related to the lastly accepted print command are saved as the final print settings in the storage 21, so that it is possible to implement the user terminal 2 that causes the digital multifunction apparatus 1 to appropriately reflect an output result expected from print settings of the image data compared to the related art regardless of a difference in applications to be used.

Preferred aspects of the disclosure include any combinations of the multiple aspects described above.

In addition to the aforementioned embodiments, various modifications of the disclosure are possible. It should not be understood that the modifications do not belong to the scope of the disclosure. The disclosure shall include meanings equivalent to the scope of the claims and all modifications within the scope.

What is claimed is:

1. An information processing apparatus comprising:
a storage that stores a program of at least one application that creates or displays image data so as to be able to activate the program;
an operator inputter that accepts a command from a user;
a display that, when the operation inputter accepts a print command of the image data with respect to an external image forming apparatus, displays a settings screen of print settings of the image data;
a communicator that, when the operation inputter accepts a print execution command of the image data with respect to the image forming apparatus, transmits the image data and the print settings; and
a controller that controls the storage, the operation inputter, the display, and the communicator,
wherein the controller determines whether a predetermined print settings save condition has been satisfied if the operation inputter accepts the print execution command of the image data from the application, saves the initial or final print settings of the image data in association with information of the application in the storage if the print settings save condition is satisfied, and causes the communicator to transmit the image data and the final print settings of the image data to the image forming apparatus, and
then causes the display to display a proposal on whether the initial print settings of the image data need to be changed to the final print settings saved in the storage to perform printing if the print settings of the image data have one or more common predetermined setting items to setting items of the initial print settings saved in association with the information of the application in the storage when the operation inputter accepts the print command of the image data from the application, and causes the communicator to transmit the image data and the final print settings saved in the storage to the image forming apparatus when the operation inputter accepts a change command of the print settings.

2. The information processing apparatus according to claim 1, wherein the one or more setting items include at least one setting item of a merge print setting and a double-sided print setting.

3. The information processing apparatus according to claim 1, wherein, if the operation inputter accepts the print command of the image data from the same application a predetermined number of times or more within a predetermined time, the controller determines that the print settings save condition has been satisfied.

4. The information processing apparatus according to claim 2, wherein, if the print settings save condition has been satisfied, the controller saves the print settings related to a lastly accepted print command among print commands accepted within a predetermined standby time in association with the information of the application as the final print settings in the storage.

5. The information processing apparatus according to claim 1, wherein, if the operation inputter accepts the print command of the image data from the application and the operation inputter accepts a command that makes it necessary to save the print settings related to the print command, the controller saves the initial and final print settings in association with the information of the application in the storage, and causes the communicator to transmit the image data and the final print settings of the image data to the image forming apparatus.
